(19) United States
(12) Patent Application Publication
(10) Pub. No.: US 2019/0219876 A1
(43) Pub. Date: Jul. 18, 2019

(54) DISPLAY PANEL AND DISPLAY DEVICE COMPRISING THE SAME

(71) Applicant: Innolux Corporation, Miao-Li County (TW)

(72) Inventors: Mao-Shiang LIN, Miao-Li County (TW); Chih-Yung HSIEH, Miao-Li County (TW); Sheng-Yun LO, Miao-Li County (TW)

(21) Appl. No.: 16/233,331

(22) Filed: Dec. 27, 2018

(30) Foreign Application Priority Data
Jan. 16, 2018 (CN) 201810039689.7
May 22, 2018 (CN) 201810493991.X

(51) Int. Cl. G02F 1/1343; G02F 1/1335; G09G 3/36

(52) U.S. Cl. CPC G02F 1/134309; G02F 1/133512; G02F 1/133514; G09G 3/3688; G02F 2001/133354; G02F 2001/134345; G02F 2201/121; G02F 2201/123; G09G 3/3677

(57) ABSTRACT

A display device includes a panel. The panel includes a first substrate; a first electrode disposed on the first substrate; a second substrate disposed opposite to the first substrate; a scan line disposed on the second substrate; a data line disposed on the second substrate and interlaced with the scan line; a first insulating layer disposed on the scan line and the data line; a second insulating layer disposed on first insulating layer; a second electrode disposed between the first insulating layer and the second insulating layer; a third electrode disposed on the second insulating layer; and a liquid crystal layer disposed between the first electrode and the third electrode, wherein the second electrode overlaps the data line in a top view.

This application claims the benefit of People's Republic of China application Serial No. 201810039689.7, filed Jan. 16, 2018 and Serial No. 201810493991.X, filed May 22, 2018, the subject matters of which are incorporated herein by reference.

### BACKGROUND

### Field of the Invention

The present disclosure relates in general to a display device, and more particularly to a specified alignment liquid crystal display device.

### Description of the Related Art

Recently, people have increasing demands on the high quality of the display image brought by the Ultra-high definition (UHD) display. However, the UHD display has a smaller pixel size and may have problems that the transmittance is too low. Further, the misalignment between the array substrate and non-array substrate may result in the drawback that variation of the transmittance of the display device is higher during manufacturing the display device. In view of this, an issue that can improve the transmittance of the display device and improve the transmittance variation caused by the misalignment of the display device is a subject worth studying.

### SUMMARY OF THE INVENTION

The disclosure is directed to a display device. Since the display device of the present disclosure is provided with an electrode disposed on the data line, the arrangement area of the black matrix on the first substrate can be reduced, thereby improving the transmittance of the display device (that is, improving the display area of the sub-pixels), or the common voltage can be more stable made by the electrode and the display quality can be improved.

According to one aspect, a display device is provided. A display device includes a panel. The panel includes a first substrate; a first electrode disposed on the first substrate; a second substrate disposed opposite to the first substrate; a scan line disposed on the second substrate; a data line disposed on the second substrate and intersecting the scan line; a first insulating layer disposed on the scan line and the data line; a second insulating layer disposed on first insulating layer; a second electrode disposed between the first insulating layer and the second insulating layer; a third electrode disposed on the second insulating layer; and a liquid crystal layer disposed between the first electrode and the third electrode, wherein the second electrode overlaps the data line in a top view.

The above and other aspects of the invention will become better understood with regard to the following detailed description. The following description is made with reference to the accompanying drawings.

### BRIEF DESCRIPTION OF THE DRAWINGS

FIG. 1 is a top view showing a portion of a display device according to one embodiment of the present disclosure.

FIG. 2A is a cross-sectional view showing a display device along line A-A′ of FIG. 1 according to one embodiment of the present disclosure.

FIG. 2B is a cross-sectional view showing a display device along line A-A′ of FIG. 1 according to one further embodiment of the present disclosure.

FIG. 3 is a cross-sectional view showing a display device according to one further embodiment of the present disclosure.

FIG. 4 is a cross-sectional view showing a display device according to one further embodiment of the present disclosure.

FIG. 5A is a top view showing a portion of a display device according to one embodiment of the present disclosure.

FIG. 5B is a cross-sectional view showing a display device along line A-A′ of FIG. 5A according to one embodiment of the present disclosure.

FIG. 6A is a top view showing a portion of a display device according to one embodiment of the present disclosure.

FIG. 6B is a cross-sectional view showing a display device along line A-A′ of FIG. 6A according to one embodiment of the present disclosure.

FIG. 7A is a top view showing a portion of a display device according to one embodiment of the present disclosure.

FIG. 7B is a cross-sectional view showing a display device along line A-A′ of FIG. 7A according to one embodiment of the present disclosure.

FIG. 8A is a top view showing a portion of a display device according to one embodiment of the present disclosure.

FIG. 8B is a cross-sectional view showing a display device along line A-A′ of FIG. 8A according to one embodiment of the present disclosure.

FIG. 9A is a top view showing a portion of a display device according to one embodiment of the present disclosure.

FIG. 9B is a cross-sectional view showing a display device along line A-A′ of FIG. 9A according to one embodiment of the present disclosure.

FIG. 10 is a cross-sectional view showing a display device according to one further embodiment of the present disclosure.

FIG. 11 is a diagram showing a relationship between a relative transmittance and an overlapping width of a display device according to one further embodiment of the present disclosure.

### DETAILED DESCRIPTION OF THE INVENTION

The present disclosure relates to a display device, and more particularly to a specified alignment liquid crystal display device. The display device of the present disclosure includes a first electrode disposed on a first substrate, a second electrode and a third electrode disposed on the second substrate. Therefore, the arrangement of the second electrode provides a larger arrangement space for the third electrode, can increase the aperture ratio, or can additionally reduce the arrangement area of the black matrix on the first substrate, or can provide a relatively stable common voltage by the second electrode, thereby improving display quality.

It will be understood that when an element or layer is referred to as being “on”, “disposed on” or “connected to” another element or layer, it can be directly disposed on or directly connected to the other element or layer, or intervening elements or layers may be present. In contrast, when an element is referred to as being “directly disposed on” or “directly connected to” another element or layer, there are no intervening elements or layers exist.

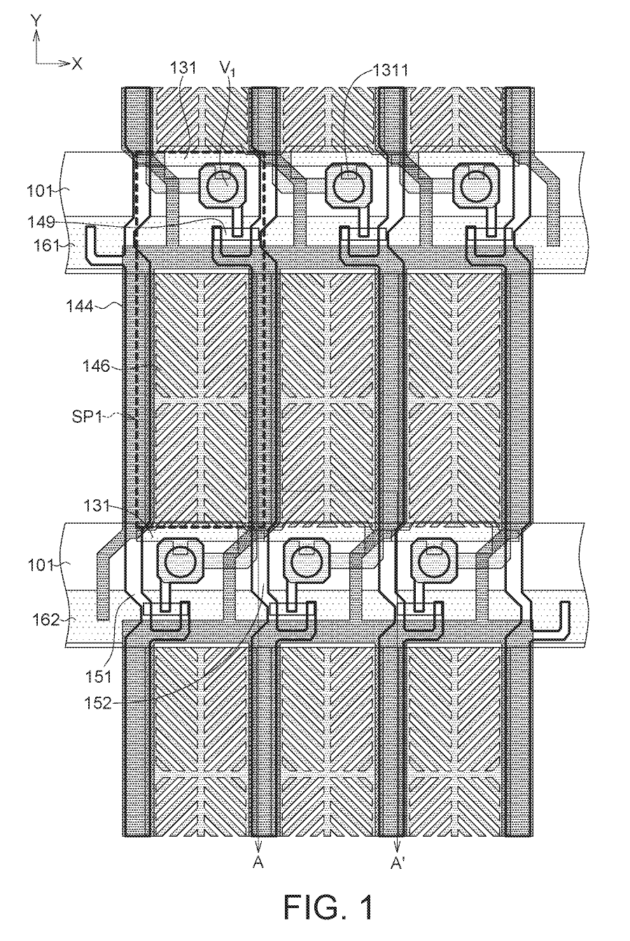

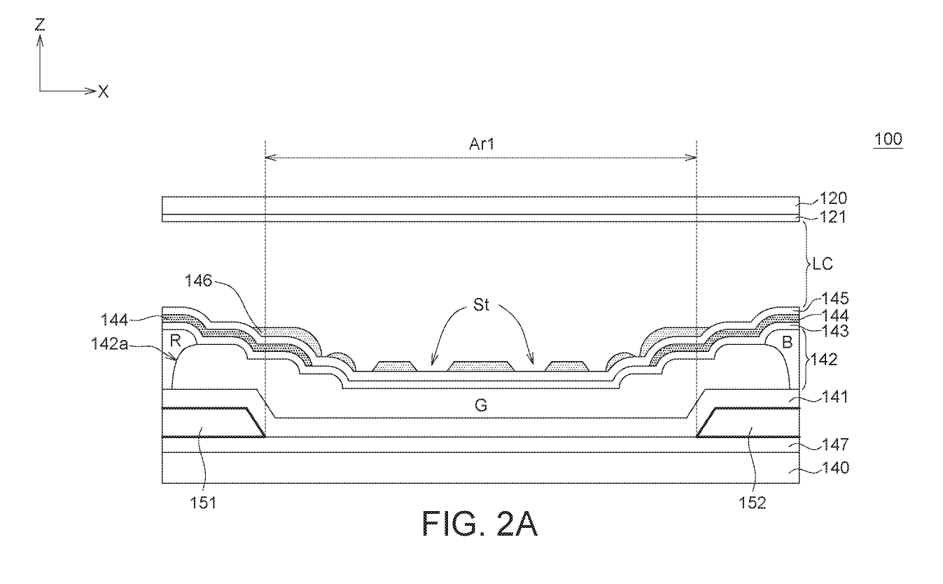

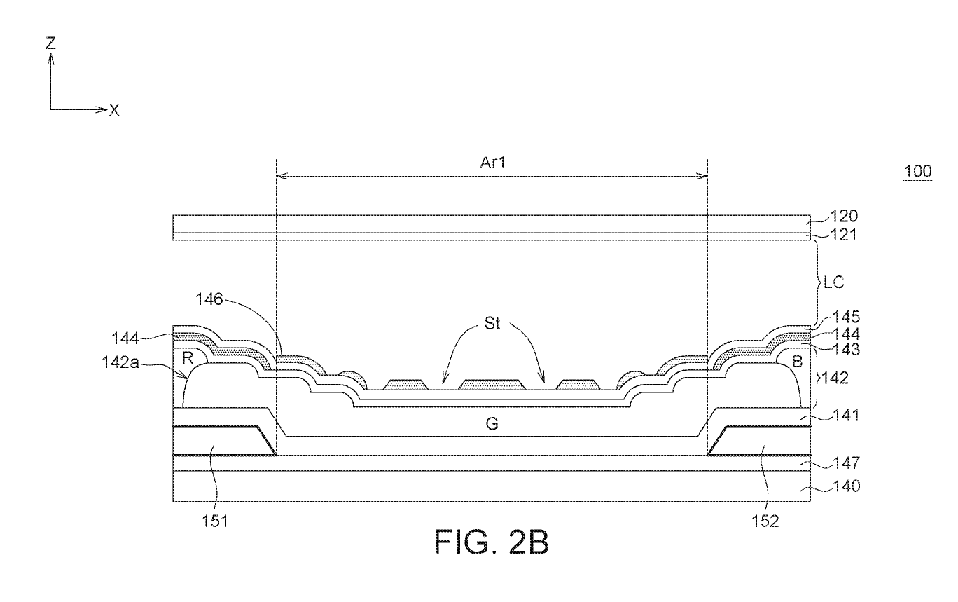

FIG. 1 is a top view showing a portion of a display device 100 according to one embodiment of the present disclosure. FIG. 2A is a cross-sectional view showing a display device 100 along line A-A′ of FIG. 1 according to one embodiment of the present disclosure. Refer to FIGS. 1 and 2A. FIGS. 1 and 2A illustrate the positional relationship between the black matrix 101 on the first substrate 120 corresponding to a sub-pixel SP1 and the data lines 151 and 152 on the second substrate 140 in the panel of the display device 100. The data lines 151 and 152 respectively extend in a first direction and are disposed along a second direction. The scan lines 161 and 162 respectively extend in the second direction and are disposed along the first direction. The second direction is different from the first direction in the top view. And the first direction usually be perpendicular to the second direction. The data lines can intersect the scan lines ed. The first direction is, for example, the Y direction, and the second direction is, for example, the X direction. The second electrode 144 and the third electrode 146 may be formed over the data lines 151 and 152. The bottom conductive layer 131 extends along the first direction. In this embodiment, the bottom conductive layer 131 may include a protrusion 1311. The protrusion 1311 can be prepared for repairing purposes. For example, when a certain pixel is abnormal, the drain of the transistor can be electrically connected to the bottom conductive layer 131 by using a laser strike, so that the pixel becomes a dark point. The third electrode 146 may divide the sub-pixel SP1 into four domains, and the third electrode 146 has a connecting segment extending in the Y direction adjacent to the data line region on both sides. The present disclosure is not limited thereto. Optionally, the connecting segment may not be disposed. In this embodiment, one sub-pixel SP1 corresponds to one data line, that is, half of the data line 151 and half of the data line 152. The via hole V₁ can electrically connect the data line 152 corresponding to the third electrode 146 and electrically connect the third electrode 146 to one end of the transistor (for example, a source or a drain). The transistor may include a semiconductor layer 149, and the material of the semiconductor layer 149 may include an amorphous silicon, a polysilicon, an oxidized semiconductor, or the like, or other suitable material as the semiconductor layer 149. The data lines 151 and 152 can be projected onto the second substrate 140 in a third direction to form a projected area. The third direction may be perpendicular to the first direction and the second direction or the third direction is different from the first direction and the second direction. The present disclosure is not limited thereto. The third direction is, for example, the Z direction. The black matrix 101 can cover substantially the middle region between the upper and lower adjacent third electrodes 146, that is, the upper portion and all of the portion of the data lines can selectively not having the arrangement of the black matrix 101, thereby improving the disadvantage of large variations in the transmittance of display device due to misalignments during the manufacturing process.

The sub-pixel SP1 shown in FIG. 1 includes a display area Ar1 (as shown in FIG. 2A) and a non-display area, and the aperture ratio is defined as the ratio of area of the display area Ar1 to the entire sub-pixel SP1 area. The range of the aperture ratio is greater than or equal to 30% and less than or equal to 60%, and the area of the display area Ar1 is the area of the sub-pixel SP1 minus the area of the non-display area, and the area of the non-display area is the area of a region that the sub-pixel SP1 is covered by the black matrix 101, the data lines 151 and 152, wherein the left and right boundaries of the sub-pixel SP1 are disposed in the X direction and at the center of the data lines 151 and 152 substantially along the Y direction, and the upper and lower boundaries of the sub-pixel SP1 are disposed in the Y direction and at lower edges of two adjacent third electrodes 146. Therefore, comparing to a comparative example that all of the area of data lines 151 and 152 are covered by the black matrix 101 (the area of the data line is defined as the entire area of the data lines 151 and 152 located between the lower edges of the two adjacent third electrodes 146), the display area Ar1 of the panel sub-pixel SP1 of the present disclosure is less possible to have misalignments caused by the first substrate 120 and the second substrate 140 in the X direction to make the sub-pixel SP1 shaded by the black matrix 101, and can have a larger area of the display area Ar1 of sub-pixel, and further enhance the transmittance of the display device.

In another embodiment, the arrangement of all of the black matrix 101 on the first substrate 120 may be removed, so that the sub-pixel SP1 have a larger display area Ar1. In a further embodiment, the black matrix 101 may also be disposed on the second substrate 140, and the misalignment of the first substrate 120 and the second substrate 140 in the Y direction, which causes the sub-pixel SP1 being shaded by the black matrix 101, can be further avoided, but the above contents is an example and is not used to limit the present disclosure.

Referring to FIGS. 2A and 2B, a cross-sectional view of a plane formed by the second direction and the third direction is shown. The third direction may be perpendicular to the first direction and the second direction, such as the Z direction. The display device 100 of the present disclosure includes a panel. The panel includes a first substrate 120, a first electrode 121, a second substrate 140, a liquid crystal layer LC (for example, a vertical alignment liquid crystal layer), data lines 151 and 152, a protective layer 141, a color filter layer 142, a first insulating layer 143, a second electrode 144, a second insulating layer 145, and a third electrode 146. It should be noted that the components and layer stacks included in the above display device 100 are examples and are not used to limit the present disclosure. The user may also add components or layers according to actual needs, or adjust the positions of components or layers. The embodiments are all within the scope of the disclosure. In an embodiment, the protective layer 141 or the first insulating layer 143 may be selectively omitted.

In FIGS. 2A and 2B, the first electrode 121 is disposed on the first substrate 120. The liquid crystal layer LC is disposed between the first substrate 120 and the second substrate 140. The data lines 151 and 152 are disposed on the second substrate 140. The protective layer 141 is disposed on the second substrate 140 and covers the data lines 151 and 152. The isolation layer 147 is disposed between the protective layer 141 and the second substrate 151. In one embodiment, the isolation layer 147 may be formed between the data lines 151 and 152 and the scan line 161 to serve as a gate protection layer. The bottom conductive layer 131 is formed between the second substrate 140 and the isolation layer 147, that is, the bottom conductive layer 131 can be formed in the same process or in the same layer as the scan line 161. The color filter layer 142 is disposed between the second substrate 140 and the first substrate 120, for example, covering the protective layer 141. The color filter layer 142 includes a red filter layer R, a green filter layer G, and a blue filter layer B. In another embodiment, the color filter layer 142 may further include a yellow filter layer Y, but is not limited thereto. The first insulating layer 143 is disposed on the color filter layer 142. The second insulating layer 145 is disposed on the first insulating layer 143. In one embodiment, the second electrode 144 is disposed between the first insulating layer 143 and the second insulating layer 145, and the second electrode 144 is at least partially overlapped with the data lines 151 and 152 in a top view in the Z-axis direction. The second electrode 144 may also cover the interface 142a of the filter layer of the adjacent color (for example, the red filter layer R and the green filter layer G), but is not limited thereto. The third electrode 146 is disposed on the second insulating layer 145. In an embodiment, the second electrode 144 and the third electrode 146 at least partially overlap each other in a top view in the Z axis direction (as shown in FIG. 2A).

In another embodiment of FIG. 2B, the second electrode 144 and the third electrode 146 may not overlap in a top view in the Z axis direction (as shown in FIG. 2B). The present disclosure is not limited thereto, depending on the needs of the person. The third electrode 146 may be a pixel electrode, and may be a patterned electrode, that is, the third electrode 146 is disposed in the display area Ar1 of a sub-pixel SP1, and may include designs of a plurality of slits St. But it is not limited. The pixel electrode can be electrically connected to the thin film transistor, and the data line can transmit the data voltage to the pixel electrode through the thin film transistor.

Further, the second electrode 144 and the first electrode 121 may have the same potential and be a common electrode, and the second electrode 144 may also be a ground electrode or a floating electrode. However, it is not limited. In another embodiment, different display driving voltages may be applied to the first electrode 121 and the second electrode 144, respectively.

The display device 100 can have the color filter disposed on the array substrate (Color on Array), which can avoid the misalignment caused by combining the color filter substrate and the array substrate, and overcome the problem of large variation of transmittance and poor color purity in the display area Ar1 of sub-pixel. The disclosure also uses the data lines 151 and 152 on the second substrate as an opaque region to improve the color mixing problem derived from the adjacent filter layer interface 142a of the color filter layer 142.

In this embodiment, the second substrate 140 may include a rigid substrate or a flexible substrate, and may be a transparent substrate or an opaque substrate, wherein the rigid substrate is, for example, glass, and the flexible substrate is, for example, polyimide (PI) or polyethylene terephthalate (PET), but the contents stated above is not limited to this embodiment, and any material can be used as long as it can be used as a rigid substrate or a flexible substrate. The data lines 151 and 152 may be formed of a metal material, such as molybdenum metal, molybdenum alloy, aluminum metal, aluminum alloy, copper metal, copper alloy, IZO, ITO or a suitable conductive material, or any combination thereof, but are not limited thereto. The isolation layer 147, the protective layer 141, the first insulating layer 143, and the second insulating layer 145 may each be an inorganic layer, and the inorganic layer may be silicon nitride (SiNx), silicon oxide (SiOx), or silicon oxynitride (SiOxNy). However, it is not limited, and as long as the material which is an inorganic compound and can be used as an insulating layer can be applied in the embodiment of the present application. The material of the third electrode 146, the first electrode 121, and the second electrode 144 is, for example, indium tin oxide (ITO), IZO, ITZO, but is not limited, as long as materials having properties which are transparent and conductive are applicable. In another embodiment, an opaque metal or a black metal, such as molybdenum (Mo), molybdenum oxide MoOx, and molybdenum nitride MoNx, may also be used in the second electrode 144, but is not limited, as long as the material which are metal materials having a reflectance of less than or equal to 30% in a visible wavelength (380 nm to 780 nm) is applicable.

In the present embodiment, the thickness of the protective layer 141 may be 1000 to 3000 Å in the direction of the Z axis. The thickness of the red filter layer R, the green filter layer G, and the blue filter layer B of the color filter layer 142 may be 2 to 4 μm, respectively. The first insulating layer 143 may have a thickness of 100 to 3000 angstroms. The second electrode 144 may have a thickness of 400 to 1400 angstroms. The second insulating layer 145 may have a thickness of 100 to 5000 angstroms. The third electrode 146 may have a thickness of 400 to 1400 angstroms. The data lines 151 and 152 may have a width of 5 to 15 μm in the X direction, respectively.

When the display device 100 is operated, different voltages may be applied to the first electrode 121 and the third electrode 146 to generate a vertical field and a fringe field between the first electrode 121 and the third electrode 146 to control the direction of the liquid crystal molecules in the vertical alignment liquid crystal layer LC. A common voltage (Vcom) may be applied to the second electrode 144 or the first electrode 121. A common voltage (Vcom) may also be applied to the bottom conductive layer 131.

When the display device 100 displays an image, the data lines 151 and 152 transmit a plurality of different gray scale voltages or the gray scale voltage transmitted from data lines is different from the voltage of the adjacent pixel, the liquid crystal molecules located in the peripheral area of the display area Ar1 (that is, near the data line 151 or 152) of the sub-pixel Sp1 will have an abnormal alignment since the data lines 151 and 152 will generate a vertical field and a fringe field, resulting in a display device 100 having an abnormality in gray scale brightness. The abnormal alignment of the liquid crystal molecules stated above indicates that the liquid crystal molecules in the peripheral region of the display area Ar1 have different pre-tilt angles or twist angles in comparison with the liquid crystal molecules at the center of the display area Ar1. Therefore, in order to solve the above problem, a second electrode 144 having a width larger than that of the data lines 151 or 152 in the X direction is disposed to shield the vertical field of the data lines 151 and 152 in the Z direction and the fringe field on the X-Z plane, thereby reducing the problems of a decrease in the contrast resulted from the abnormal gray scale brightness caused by the abnormal alignment of liquid crystal molecules in the peripheral area Ar1.

In addition, in comparison with the comparative example in which the black matrix of the first substrate of the prior art needs to completely cover the data line, the setting range of the third electrode 146 can extend outwardly by the arrangement of the second electrode 144 of the present disclosure, and the extension causes the display area Ar1 to become larger. For example, in comparison with the comparative example which is a 65 inches 8K4K (resolution 7680×4320) panel having the black matrix of the first substrate of the prior art completely covering the data line so that the open area (display area) being limited to the region between the black matrix of the first substrate, the embodiment of the present disclosure can increase the display area by about 40%, and the transmittance increases from 2.8% to 4%.

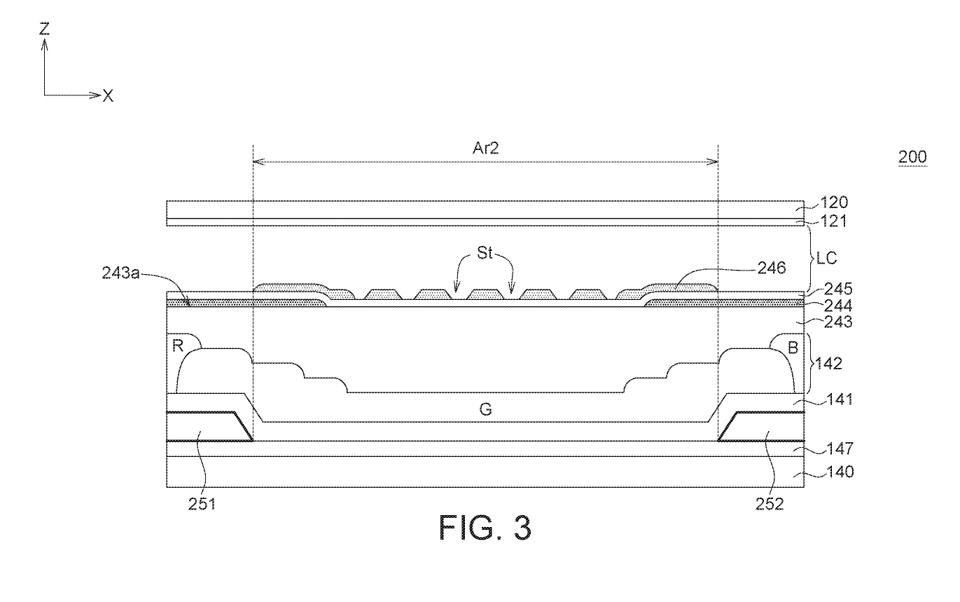

FIG. 3 is a cross-sectional view of a display device 200 according to a further embodiment of the present disclosure.

The position of the cross-sectional view shown in the display device 200 in FIG. 3 is similar to the position of the cross-sectional view shown in the display device 100 in FIG. 2A. The display device 200 of FIG. 3 differs from the display device 100 of FIG. 2A in the material of the first insulating layer 243.

Referring to FIG. 3, the first insulating layer 243 is an organic compound layer, and may be, for example, a polymer, a PFA (Polyimide Film on Array) or a photoresist material. For example, the photoresist material may be a polymer material such as an epoxy resin or an acrylic resin, but it is not limited, and any embodiment of the present disclosure can be applied as long as it is an organic compound and can be applied to a material which is used as an insulating layer. Therefore, the first insulating layer 243 has a substantially flat upper surface 243a. The second insulating layer 245 is an inorganic layer. As a result, the second electrode 244, the second insulating layer 245, and the third electrode 246 above the first insulating layer 243 of the present embodiment may be stacked on the flat upper surface 243a, and have a smaller height difference in the Z direction, which allows the liquid crystal molecules in the display area to have a good alignment, thereby alleviating the situation of light leakage in the dark state. In this embodiment, the second electrode 244 and the third electrode 246 are at least partially overlapped in a top view in the direction of the Z-axis. In other embodiments, the second electrode 244 and the third electrode 246 may not overlap each other in a top view in the direction of the Z-axis, but is not limited thereto, and depends on user's requirements. In another embodiment, the third electrode 246 can also selectively cover portions of the data lines 251 and 252, that is, viewed in the direction of the Z-axis, and the third electrode 246 partially overlaps the data lines 251 and 252. It is not limited, but depends on the needs of design.

In the present embodiment, the protective layer 141 may have a thickness of 1000 to 3000 angstroms in the direction of the Z-axis. The color filter layer 142 may have a thickness of 2 to 4 micrometers. The thickness of the first insulating layer 243 may be 1 to 4 μm. The second electrode 244 may have a thickness of 400 to 1400 angstroms. The second insulating layer 245 may have a thickness of 100 to 5000 angstroms. The third electrode 246 may have a thickness of 400 to 1400 angstroms. Since the first insulating layer 243 of the present embodiment has a larger thickness, a problem that the liquid crystal molecule in the peripheral region have abnormal alignment of liquid crystal layer LC for the difference of surface fluctuations due to the third electrode 146 having a large variation in slope in the peripheral region of the display region Ar2 is improved, which in turn improves the display quality of the display device 200 and further improves the contrast. Furthermore, since the third electrode 146 no longer has a larger variation in slope in the peripheral region of the display region Ar2, the requirement to use opaque data lines 251 and 252 to shield the light leakage in a dark state caused by the liquid crystal molecules in the peripheral region of the display region Ar2 due to the surface fluctuations will be further reduced, and the width of the data lines 251 and 252 in the X direction can be reduced. The width of the data lines 251 and 252 is, for example, 5 to 12 microns. Thereby, the display device 200 of the present embodiment can have a larger display area Ar2 than that of the display device 100 of FIG. 2.

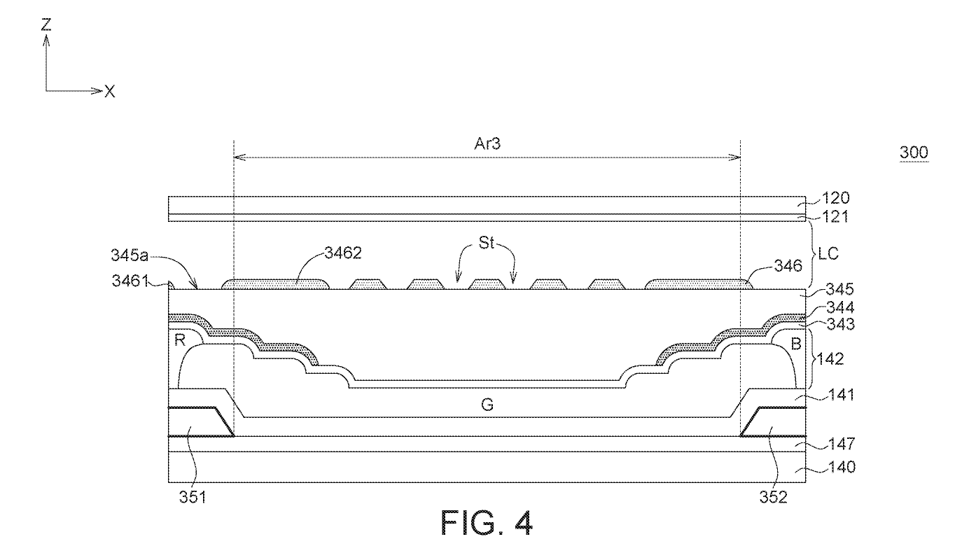

FIG. 4 is a cross-sectional view of a display device 300 according to a further embodiment of the present disclosure.

The position of the cross-sectional view of the display device 300 in FIG. 4 is similar to the position of the cross-sectional view of the display device 100 in FIG. 2A. The display device 300 of FIG. 4 differs from the display device 100 of FIG. 2A in the material of the second insulating layer 345. In the present embodiment, the second electrode 344 and the third electrode 346 are overlapped with each other in a top view in a direction of a Z-axis. In other embodiments, the second electrode 344 and the third electrode 346 may not overlap each other in a top view in a direction of the Z-axis, but is not limited thereto, and depends on user requirements. In an embodiment, the third electrode 346 may include a first pixel electrode 3461 corresponding to the red filter layer R and a second pixel electrode 3462 corresponding to the green filter layer G. The first pixel electrode 3461 and the second pixel electrode 3462 may be located on both sides of the data line 351, respectively.

Referring to FIG. 4, the first insulating layer 343 may be an inorganic layer, and the second insulating layer 345 may be an organic compound layer, so that the second insulating layer 345 has a substantially flat upper surface 345a. In this way, since the third electrode 346 of the present embodiment can be disposed on the approximately flat upper surface 345a and has a smaller height difference in a top view in the direction of the Z-axis, the liquid crystal layer LC in the display region can have a better alignment to reduce the light leakage in a dark state.

In the present embodiment, the protective layer 141 may have a thickness of 1000 to 3000 angstroms in the direction of the Z-axis. The color filter layer 142 may have a thickness of 2 to 4 microns. The first insulating layer 343 may have a thickness of 100 to 3000 angstroms. The second electrode 344 may have a thickness of 400 to 1400 angstroms. The thickness of the second insulating layer 345 may be 1 to 4 μm. The third electrode 346 may have a thickness of 400 to 1400 angstroms. Since the second insulating layer 345 of the present embodiment has a large thickness, the variation in the slope of the third electrode 346 can be reduced, and the display quality of the display device 300 can be further improved. Therefore, the use of the opaque data lines 351 and 352 to shade the light leakage in the dark state caused by the surface fluctuations of the liquid crystal molecules in the peripheral region of the display area Ar3 can be further reduced, and the width of the data lines 351 and 352 in the X-axis, for example, 5 to 12 micrometers, can be reduced. Moreover, since the second insulating layer 345 of the embodiment has a larger thickness, the storage capacitance can be reduced, so that the overlapping area between the second electrode 344 and the third electrode 346 can be increased, and the area of the third electrode 346 can also be increased. Thereby, the display device 300 of the embodiment can further have a larger display area Ar3.

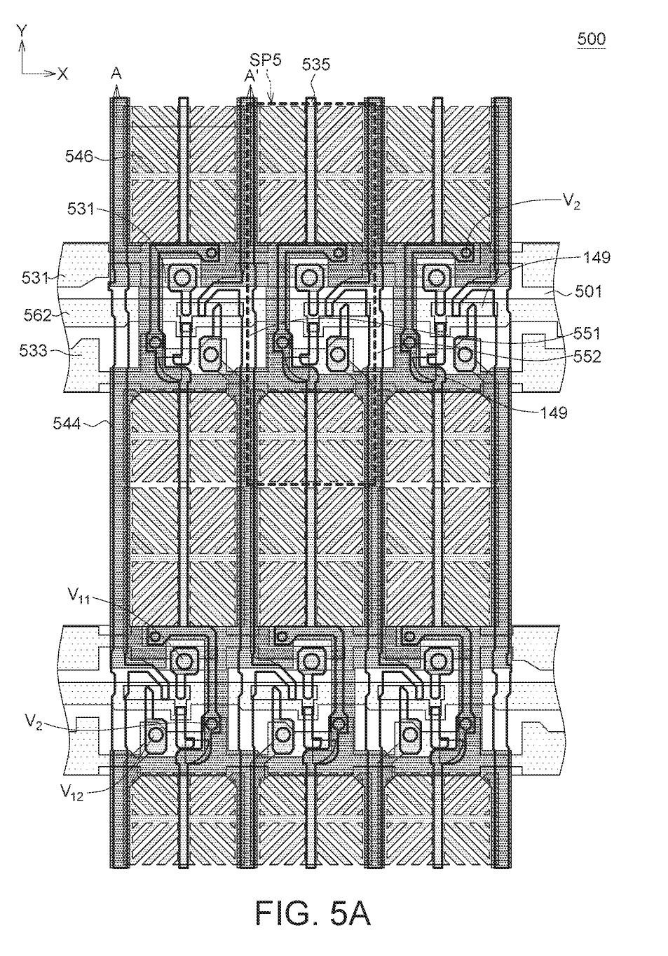

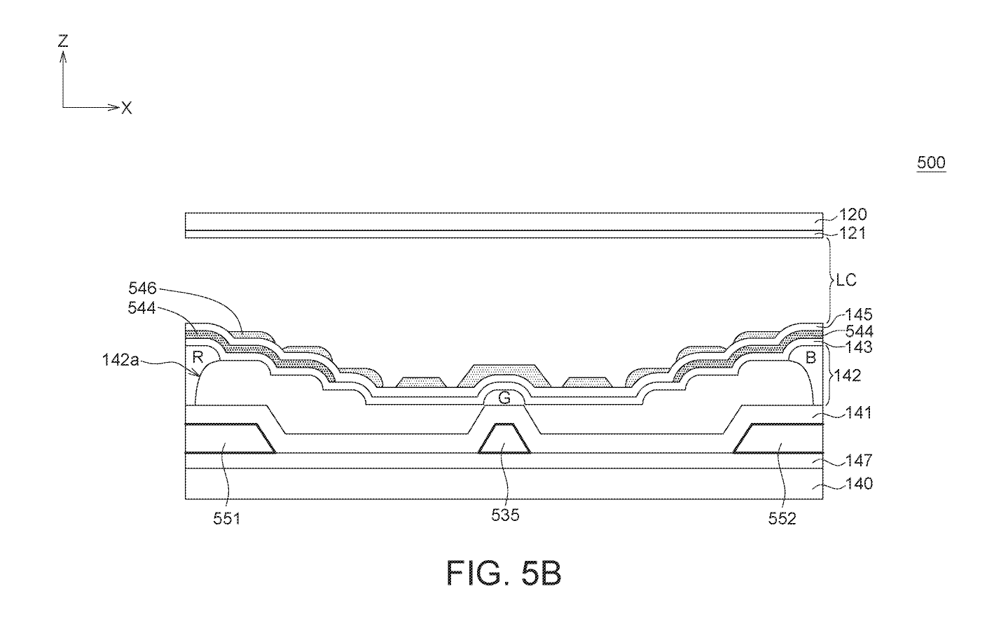

FIG. 5A is a top view showing a portion of a display device 500 according to one embodiment of the present disclosure. FIG. 5B is a cross-sectional view showing a display device 500 along line A-A′ of FIG. 5A according to one embodiment of the present disclosure. A portion of the structure of the display device 500 is similar to that of the display device 100. The display device 500 of FIG. 5A is different from the display device 100 of FIG. 1 in that the sub-pixel SP5 is divided into eight domains, which can be used to compensate for the visual color difference, and both of two sides of the scanning line 562 in the second direction (for example, the X direction) have provided with bottom conductive layers 531 and 533, and the bottom conductive layers 531 and 533 extend approximately in the second direction, respectively. The middle conductive layer 535 is located substantially at the center of the sub-pixel SP5 and extends substantially in the first direction.

Refer to the FIGS. 5A and 5B. In this embodiment, one sub-pixel SP5 corresponds to one data line, i.e. corresponding to half of the data line 551 and half of the data line 552. In a sub-pixel SP5, there are four domains on the upper and lower sides of the scanning line 562, respectively. The black matrix 501 can be disposed in the middle portion of the sub-pixel SP1, selectively covering at least a portion of the bottom conductive layers 531 and 533, the scan lines 562, or the data lines 551 and 552. The second electrode 544 extends approximately along the periphery of the sub-pixel SP5, and the second electrode 544 may overlap with at least a portion of the bottom conductive layers 531 and 533, the scan line 562, or the data lines 551 and 552. Each of the bottom conductive layers 531 and 533 extends substantially along a second direction (eg., X direction). The bottom conductive layers 531 and 533 are both formed between the second substrate 140 and the isolation layer 147 (not shown). The middle conductive layer 535 can be formed in the same process as the data lines 551 and 552, and is located between the isolation layer 147 and the protective layer 141. A common voltage may be applied to the bottom conductive layers 531 and 533, respectively, and a common voltage may be applied to the middle conductive layer 535. The via hole V₂ can electrically connect the middle conductive layer 535 and the bottom conductive layer 531, 533. The via hole V₁₁ can electrically connect the data line to the upper portion of the pixel electrode (for example, the third electrode 546 located at the upper portion above the scan line 562). The via hole V₁₂ can electrically connect the data line to the lower portion of the pixel electrode (for example, the third electrode 546 located under the scan line 562).

In this embodiment, the second electrode 544 and the third electrode 546 at least partially overlap each other in a top view in a direction of the Z axis (as shown in FIG. 5A). In comparison with the comparative example in which the black matrix of the first substrate of the prior art needs to completely cover the data line, the arrangement range of the third electrode 546 can be outwardly extended by the arrangement of the second electrode 544 so that the display area Ar1 is enlarged. In other embodiments, the second electrode 544 and the third electrode 546 may not overlap in a top view in a direction of a Z axis (not shown). Moreover, by providing a second electrode 544 whose width is larger than the data line 551 or 552 in the X direction, thereby shielding the vertical field of the data lines 551 and 552 in the Z direction and the fringe field in the X-Z plane, and the problem of a decrease in contrast caused by the abnormal gray scale brightness triggered by abnormal alignment of liquid crystal molecules in the periphery of display area Ar1 is reduced. In addition, since one sub-pixel SP1 of the present embodiment has 8 domains, an additional pixel voltage can be provided in comparison with a comparative example having 4 domains in one sub-pixel, so the color difference while viewing at a large angle, can be reduced. However, this does not limit the number of domains of the sub-pixels, but depends on the design requirements.

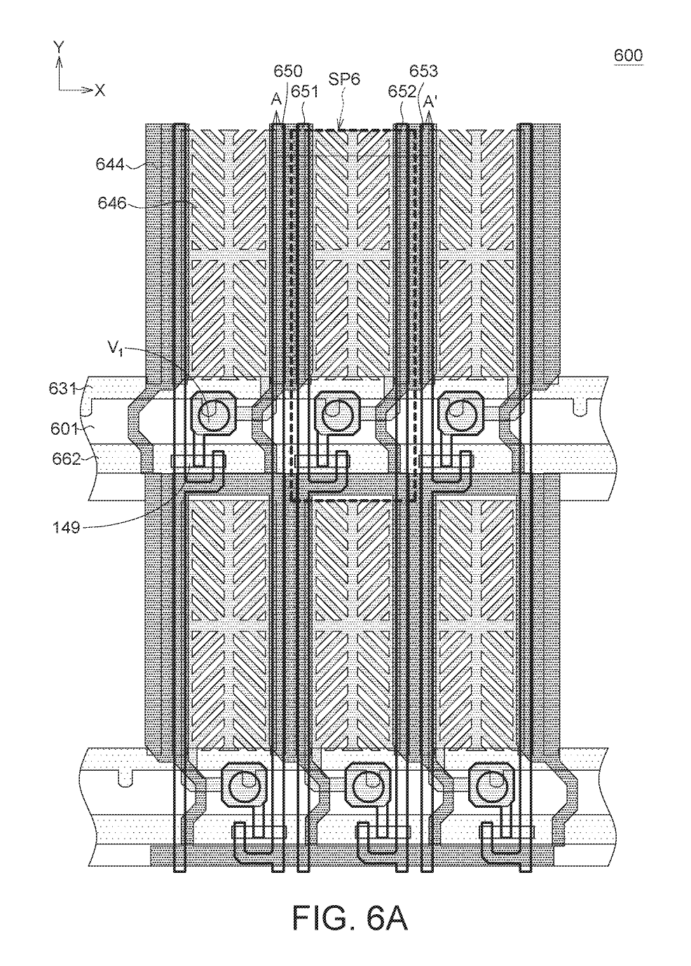

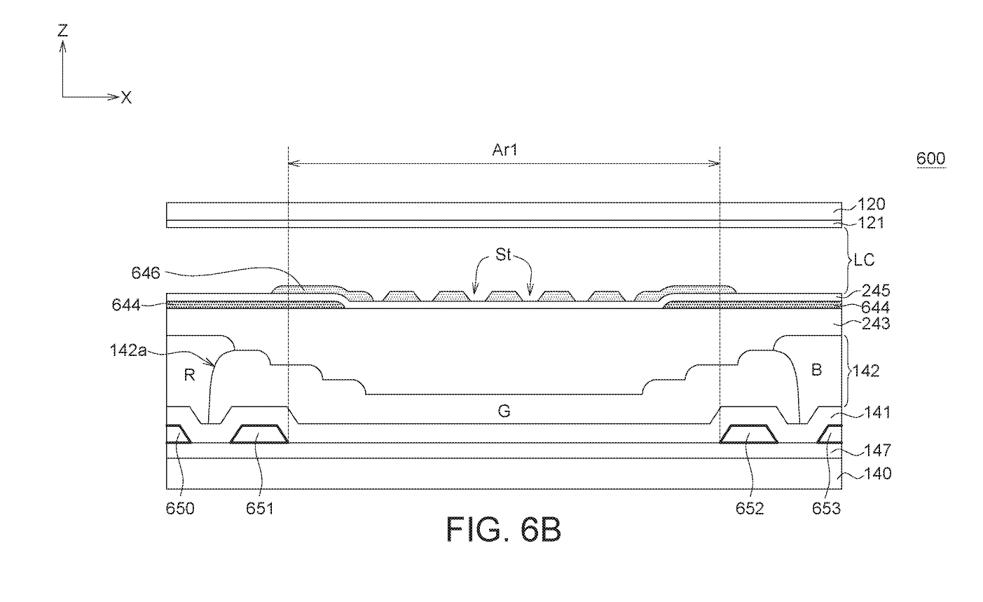

FIG. 6A is a top view showing a portion of a display device 600 according to one embodiment of the present disclosure. FIG. 6B is a cross-sectional view showing a display device 600 along line A-A′ of FIG. 6A according to one embodiment of the present disclosure. A portion of the structure of the display device 600 is similar to that of the display device 100. The display device 500 of FIG. 6A is different from the display device 100 of FIG. 1 in that a sub-pixel SP6 corresponds to two data lines 651 and 652, and the second electrode 644 overlaps two data lines 651 and 652 in a third direction in a sub-pixel SP6.

Refer to the FIGS. 6A and 6B. One sub-pixel SP6 corresponds to the data line 651 on the left side and the data line 652 on the right side. The third electrode 646 divides the sub-pixel SP6 into four domains. The black matrix 601 covers at least a portion of the bottom conductive layer 631, the scan line 662, via hole V₁, or the data lines 650, 651, 652, and 653. A portion of the second electrode 644 extends along the first direction and covers the boundary region of the adjacent two sub-pixels, for example, covering the data lines 650 and 651, or covering the data lines 652 and 653. The via hole V₁ can electrically connect the data line (for example, the data line 651) and the pixel electrode (for example, the third electrode 646). In this embodiment, the bottom conductive layer 631 and the third electrode 646 can be electrically connected to a peripheral area outside the active area, or can be selectively connected to the active area. It depends on design requirements, and is not limited here.

In the present embodiment, the second electrode 644 and the third electrode 646 at least partially overlap each other in a top view in a direction of the Z axis (as shown in FIG. 6A). In comparison with the comparative example in which the black matrix of the first substrate of the prior art needs to completely cover the data line, the arrangement of third electrode 646 can be outwardly extended by the arrangement of the second electrode 644, so that the display area Ar1 is enlarged. In other embodiments, the second electrode 644 and the third electrode 646 may not overlap in a top view in a direction of Z axis (not shown). In other embodiments, the third electrode 646 and the data line may also selectively do not overlap in a top view in a direction of a Z-axis (not shown), and are not limited thereto. Moreover, the vertical field in the Z direction and the fringe field in the X-Z plane of the data line 650, 651, 652 or 653 are shielded by providing a second electrode 644 having a width larger than the data line 650, 651, 652 or 653 in the X direction, the problem, which is a decrease in contrast resulted from the abnormality of the gray scale brightness caused by the abnormal alignment of liquid crystal molecules in the peripheral area of the display area Ar1, is reduced.

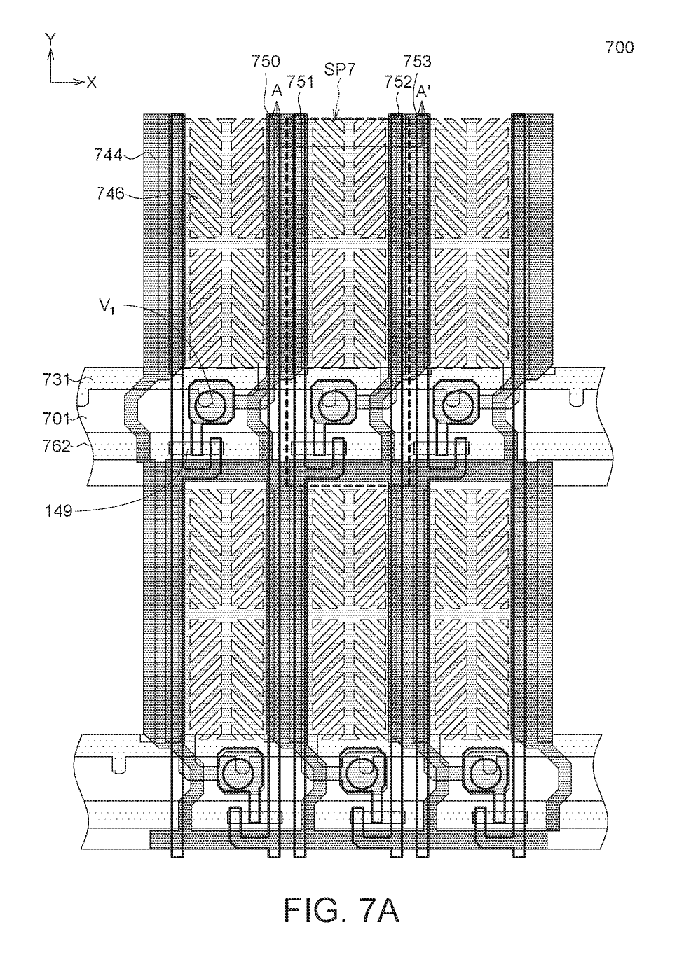

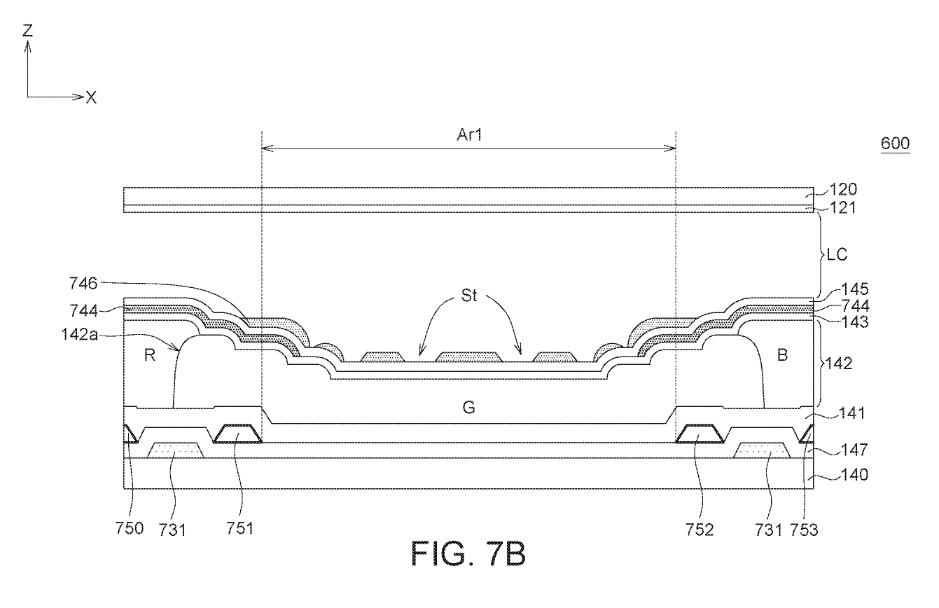

FIG. 7A is a top view showing a portion of a display device 700 according to one embodiment of the present disclosure. FIG. 7B is a cross-sectional view showing a display device 700 along line A-A′ of FIG. 7A according to one embodiment of the present disclosure. A portion of the structure of the display device 700 is similar to that of the display device 600. The display device 700 of FIGS. 7A and 7B is different from the display device 600 of FIGS. 6A and 6B in that a portion of the bottom conductive layer 731 extending in the first direction (for example, the Y direction), is disposed at the boundary area between the two adjacent sub-pixels and is disposed between the two data lines.

Refer to FIGS. 7A and 7B. The sub-pixel SP7 corresponds to the data line 751 on the left side and the data line 752 on the right side. The third electrode 746 divides the sub-pixel SP7 into four domains. A portion of the bottom conductive layer 731 extends along the Y direction, and a portion of the bottom conductive layer 731 extends along the X direction. In a sub-pixel SP7, the bottom conductive layer 731 has a shape similar to a U-shape, selectively corresponding to three sides of a rectangular region formed by the third electrode 746. The bottom conductive layer 731 extending along the X direction corresponds to the boundary region of the adjacent two sub-pixels, for example, between the data lines 750 and 751 of different sub-pixels, or between the data lines 752 and 753 of different sub-pixels. Moreover, the bottom conductive layer 731 extending along the Y direction can be viewed from the Z direction, and the bottom conductive layer 731 and two data lines of different pixels (for example, the data lines 750, 751, 752, and 753) can be non-overlapped and staggered from each other. The black matrix 701 can selectively cover at least a portion of the bottom conductive layer 731, the scan lines 762, the via hole 748, or the data lines 750, 751, 752, and 753. A portion of the second electrode 744 extends along the Y direction and covers a boundary region of two adjacent sub-pixels, for example, covering data lines 750 and 751 of adjacent sub-pixels, or covering data lines 752 and 753 of adjacent sub-pixels. The via hole V₁ can electrically connect the data line (for example, the data line 751) and the pixel electrode (for example, the third electrode 744). In this embodiment, the bottom conductive layer 731 and the third electrode 744 may be electrically connected to the peripheral circuit region outside the active area to supply a potential, or may be selectively connected to the active area. However, the disclosure is not limited thereto.

In this embodiment, the second electrode 744 and the third electrode 746 may at least partially overlap each other in a top view in a direction of a Z-axis (as shown in FIG. 7A). In other embodiments, the second electrode 744 and the third electrode 746 may not overlap in a top view in a direction of a Z axis (not shown). In this embodiment, the third electrode 746 may partially overlap the data line. However, in other embodiments, the third electrode 746 may also selectively be non-overlapped with the data line, which is not limited thereto.

The process error of the different color sub-pixels generated by the color filter layer 142 during the manufacturing process can be shaded by setting the bottom conductive layer 731 to correspond to the boundary region of the adjacent two sub-pixels, for example, between the data lines 750 and 751 of different sub-pixels (red sub-pixels and green sub-pixels), or between the data lines 752 and 753 of the different sub-pixels (green sub-pixels and blue sub-pixels). Moreover, the problem which is a decrease in contrast resulted from the abnormal gray scale brightness caused by the abnormal alignment of liquid crystal molecules in the peripheral region of the display region Ar1 can be reduced by providing a second electrode 744 having a width greater than the total width of the data lines 750, 751 in the X direction, thereby shielding the vertical field of the data lines 750, 751 in the Z direction and the fringe field in the X-Z plane. In addition, the second electrode 744 is not only capable of connecting the common electrodes in the horizontal direction and the vertical direction, but also has better stability, and the signals can be connected in the area facing outside, so that it is not necessary to set more via holes in the area facing inside, and the loss of the aperture ratio caused by the via holes can be avoided.

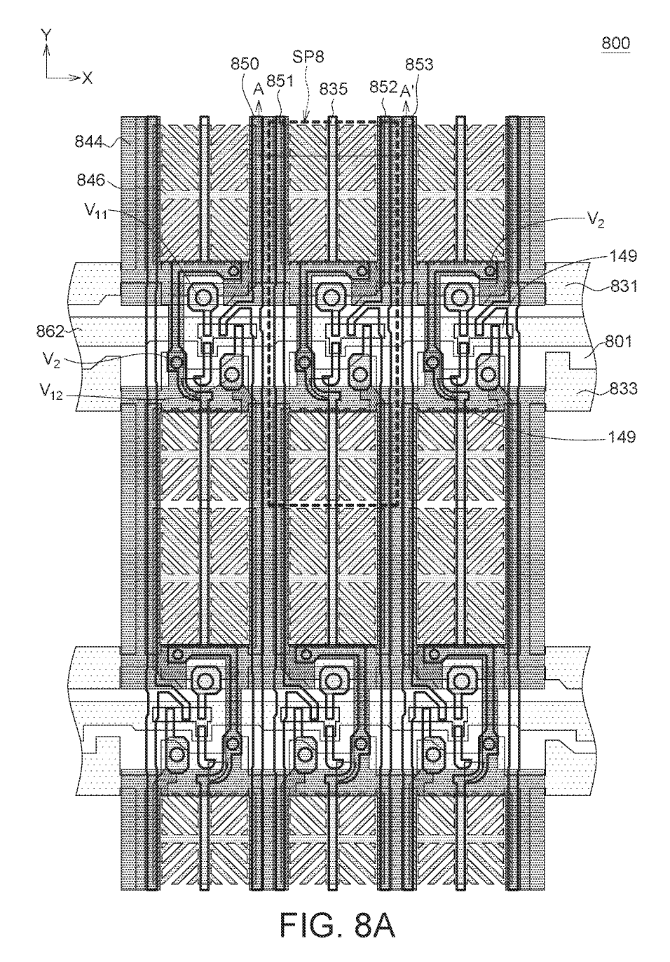

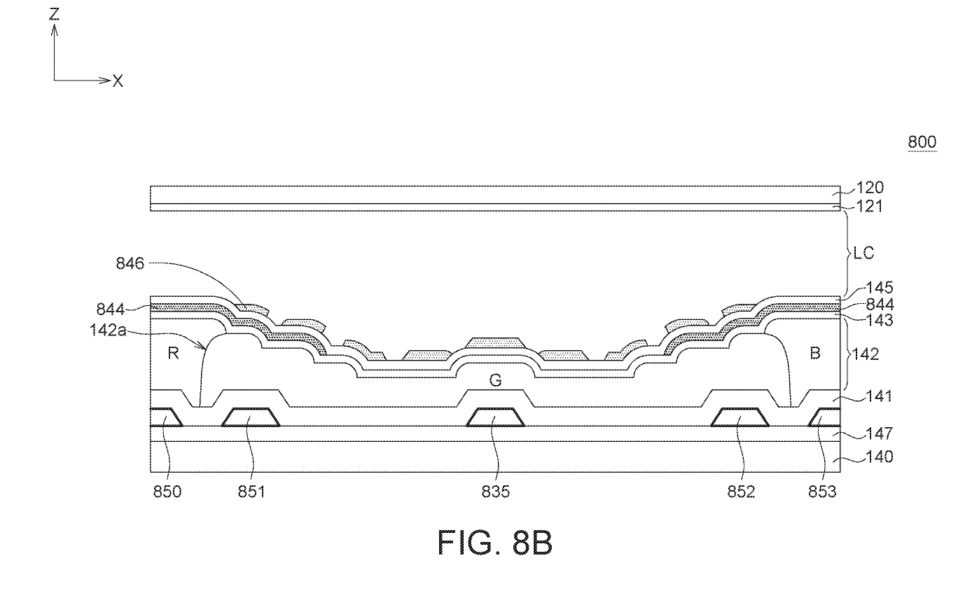

FIG. 8A is a top view showing a portion of a display device 800 according to one embodiment of the present disclosure. FIG. 8B is a cross-sectional view showing a display device 800 along line A-A′ of FIG. 8A according to one embodiment of the present disclosure. A portion of the structure of the display device 800 is similar to that of the display device 500. The display device 800 of FIGS. 8A and 8B is different from the display device 500 of FIGS. 5A and 5B in that a sub-pixel SP8 corresponds to two data lines 851 and 852, and the second electrode 844 overlaps two data lines 851 and 852 in the third direction in a sub-pixel SP8.

Refer to FIGS. 8A and 8B. One sub-pixel SP8 corresponds to the data line 851 on the left side and the data line 852 on the right side. The third electrode 846 in the sub-pixel SP8 is divided into eight domains, and has four domains on both sides of the scan line 862. The scan line 862, the via holes V₂, V₁₁, V₁₂, and the black matrix 801 are located in the middle portion of the sub-pixel SP8. The bottom conductive layers 831 and 833 are disposed on both sides of the scan line 862, and the bottom conductive layers 831 and 833 respectively extend along the X direction. The black matrix 801 covers portions of the bottom conductive layers 831 and 833, the scan line 862, the via holes V₂, V₁₁, V₁₂, and data lines 850, 851, 852, and 853. A portion of the second electrode 844 extends along the X direction, and a portion of the second electrode 844 extends along the Y direction. The second electrode 844 extending along the Y direction covers the boundary area of the two adjacent sub-pixels in the third direction (in the top view direction), for example, covering the data lines 850 and 851 of different sub-pixels, or covering data lines 852 and 853 of different sub-pixels. The via hole V₂ can electrically connect the middle conductive layer 835 to the bottom conductive layers 831, 833. The via hole V₁₁ can electrically connect the data line to the upper portion of the pixel electrode (for example, the upper portion of the third electrode 846). The via hole V₁₂ can electrically connect the data line to the lower portion of the pixel electrode (for example, the lower portion of the third electrode 846).

In this embodiment, the second electrode 844 and the third electrode 846 at least partially overlap each other in a top view in a direction of a Z-axis (as shown in FIG. 8A). In other embodiments, the second electrode 844 and the third electrode 846 may not overlap in a top view in a direction of a Z-axis (not shown). Moreover, the problem which is a decrease in contrast resulted from the abnormal gray scale brightness caused by the abnormal alignment of liquid crystal molecules in the peripheral region of the display region Ar1 is reduced by providing a second electrode 844 having a width greater than the total width of the data lines 850, 851 in the X direction, thereby shielding the vertical field of the data lines 850, 851 in the Z direction and the fringe field in the X-Z plane.

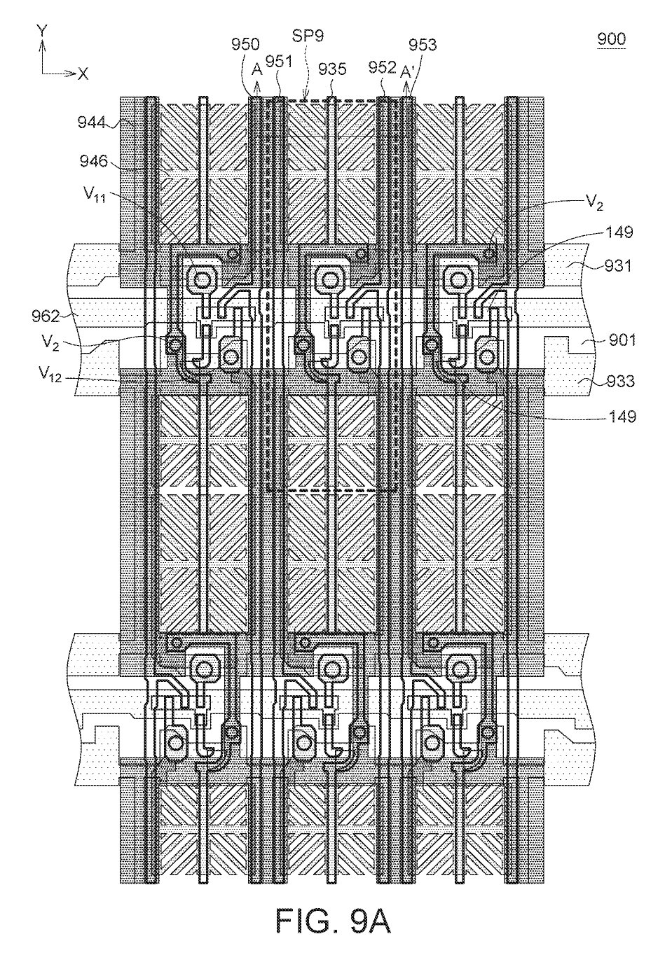

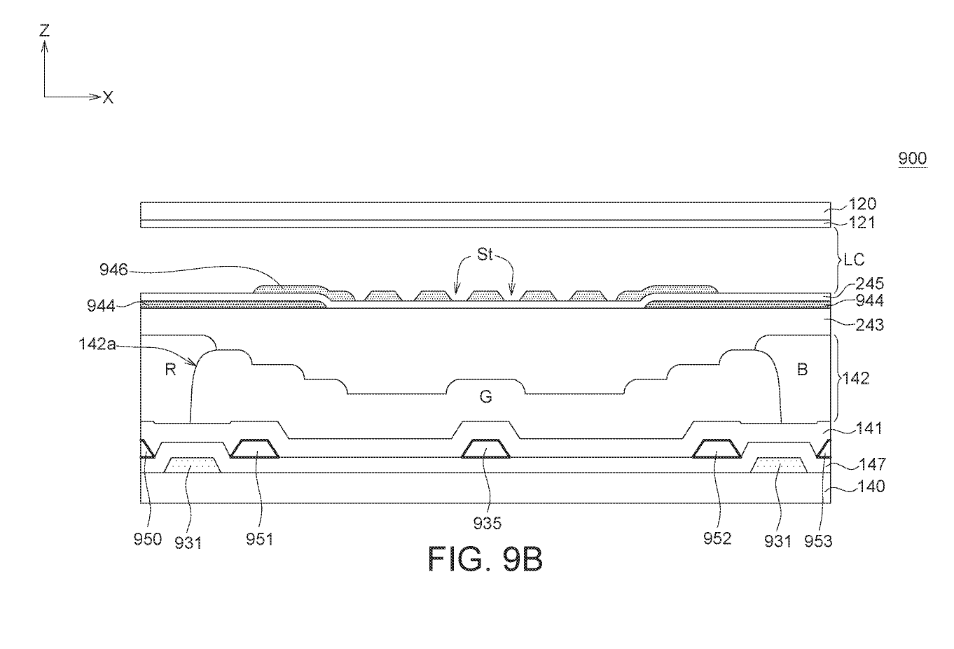

FIG. 9A is a top view showing a portion of a display device 900 according to one embodiment of the present disclosure. FIG. 9B is a cross-sectional view showing a display device 900 along line A-A′ of FIG. 9A according to one embodiment of the present disclosure. A portion of the structure of the display device 900 is similar to that of the display device 800. The display device 900 of FIGS. 9A and 9B is different from the display device 800 of FIGS. 8A and 8B in that a portion of the bottom conductive layers 931 and 933 extends in the first direction and corresponds to a boundary region of two adjacent sub-pixels in the third direction (top view direction).

Refer to the FIGS. 9A and 9B. The sub-pixel SP9 corresponds to the data line 951 on the left side and the data line 952 on the right side. In one sub-pixel SP9, the bottom conductive layers 931 and 933 are U-shaped and inverted U-shaped, respectively, corresponding to three sides of the rectangular region formed by the third electrode 946. A portion of the bottom conductive layers 931 and 933 extend along the first direction and corresponds to the boundary regions of the adjacent two sub-pixels, for example, between the data lines 950 and 951 of different sub-pixels in a third direction, or between the data lines 952 and 953 of different sub-pixels in the third direction. The black matrix 901 can cover portions of the bottom conductive layers 931 and 933, the scan line 962, the via hole 948, and the data lines 950, 951, 952, and 953. A portion of the second electrode 944 extends along the X direction, and a portion of the second electrode 944 extends along the Y direction. The second electrode 944 extending along the Y direction covers the boundary region of the two adjacent sub-pixels in the third direction (the top view direction), for example, covering the data lines 950 and 951 of different sub-pixels, or covering data lines 952 and 953 of different sub-pixels. The via hole V₂ can electrically connect the middle conductive layer 935 to the bottom conductive layers 931 and 933. The via hole V₁₁ can electrically connect the data line to the upper portion of the pixel electrode (for example, upper portion of the third electrode 946). The via hole V₁₂ can electrically connect the data line to the lower portion of the pixel electrode (for example, lower portion of the third electrode 946).

In the present embodiment, the second electrode 944 and the third electrode 946 may at least partially overlap each other in a top view in a direction of the Z axis (as shown in FIG. 9A). In other embodiments, the second electrode 944 and the third electrode 946 may not overlap in a top view in a direction of a Z axis (not shown). In this embodiment, the third electrode 946 may partially overlap the data line. However, in other embodiments, the third electrode 946 may also be selectively non-overlapped to the data line. It is not limited thereto. The third electrode 946 has a connecting segment extending along the Y direction in a region adjacent to the data line on both sides, but the connecting segment may be selectively not disposed, which is not limited thereto.

The process error of the different color sub-pixels generated by the color filter layer 142 during the manufacturing process can be shaded by disposing the bottom conductive layers 931 and 933 to correspond to the boundary regions of the adjacent two sub-pixels, for example, between data lines 950 and 951 of different sub-pixels (red sub-pixels and green sub-pixels), or between the data lines 952 and 953 of different sub-pixels (green sub-pixels and blue sub-pixels). Moreover, a problem which is a decrease in contrast resulted from the abnormal gray scale brightness caused by the abnormal alignment of liquid crystal molecules in the peripheral region of the display region Ar1 is reduced by providing a second electrode 944 having a width greater than the total width of the data lines 950, 951 in the X direction, thereby shielding the vertical field in the Z direction and the fringe field in the X-Z plane of the data lines 950, 951. In addition, the second electrode 944 can be connected not only to the common electrode in the horizontal direction and the vertical direction, but also to improve the stability and improve the display quality, and the signal can be connected in the area facing outside, so that the arrangement of more via holes in the area facing inside is not needed, and the loss of the aperture ratio due to the via holes can be avoided.

FIG. 10 is a cross-sectional view showing a relative relationship between the second electrode, the third electrode and the data lines according to one further embodiment of the present disclosure.

The second electrode 444, the third electrode 446, and the data line 451 of FIG. 10 may be similar to the second electrodes 144, 244, and 344, and the third electrodes 146, 246, and 346, and data lines 151, 251 and 351 of the display devices 100, 200, and 300, respectively. The third electrode 446 in FIG. 10 includes a first pixel electrode 4461 and a second pixel electrode 4462.

The display devices 100, 200, and 300 of the present disclosure can be applied to, for example, a Polymer Stabilization Vertical Alignment (PSVA) liquid crystal panel. In the process of manufacturing the display devices 100, 200, and 300, it may be necessary to cure the liquid crystal molecules so that the liquid crystal molecules can respectively have a pre-tilt angle depending on the position, and the liquid crystal molecules can have a better arrangement when a driving voltage is applied to the display device. The first pixel electrode 4461 and the second pixel electrode 4462 have a first distance D₁ in the X direction. When curing is performed, the first pixel electrode 4461, the second pixel electrode 4462, and the data line 451 are equipotential, so that the liquid crystal molecules corresponding to and above the first distance D₁ may be poorly arranged. Since the second electrode 444 is further disposed between the first pixel electrode 4461 and the second pixel electrode 4462, the second electrode 444 and the first electrode (not shown) on the first substrate 120 can provide an additional electric field (for example, the voltage difference between the second electrode 444 and the first electrode is less than 1.5 volts (V), so that the above liquid crystal molecules corresponding to the first distance D₁ are fixed in a vertical arrangement without interfering with the arrangement of the surrounding liquid crystal molecules) and allows the liquid crystal molecules between the first pixel electrode 4461 and the second pixel electrode 4462 to be better arranged. Therefore, in comparison with the comparative example in which the second electrode is not disposed, since the second electrode 444 of the present disclosure is disposed between the first pixel electrode 4461 and the second pixel electrode 4462, the first distance D₁ can be reduced. The transmittance can also be increased. For example, the first distance D₁ can be greater than or equal to 4 micrometers and less than or equal to 21 micrometers.

In one embodiment of the present disclosure, the second electrode 444 disposed on the second substrate 140 has a first width W₁ in the X direction, and the data line 451 has a second width W₂ in the X direction. A width W₁ is greater than the second width W₂. The second electrode 444 has a first edge 444a adjacent to the first pixel electrode 4461 and a first edge 444b adjacent to the second pixel electrode 4462. A second distance D₂ in the X direction is between the first edge 444a and the data line 451 projected on the second substrate 140, and a third distance D₃ in the X direction is between the second edge 444b and the data line 451 projected on the second substrate 140. The second distance D₂ may be substantially equal to the third distance D₃. The sum of the second distance D₂ and the third distance D₃ represents a difference value between the first width W1 and the second width W₂, which is, for example, greater than or equal to 1 micrometer and less than or equal to 8 micrometers. Therefore, in comparison with the comparative example in which the second electrode is not provided, since the second electrode 444 of the present disclosure is disposed above the data line 451, the width of the second electrode 444 is larger than the width of the data line 451, and the problem of light leakage in a dark state in a display device caused by the vertical field and the fringe field of data line 451 can be sufficiently improved.

In one embodiment of the present disclosure, an overlapping width D₄ is between the second electrode 444 and the third electrode 446 (e.g., the pixel electrode 4462) in the X direction. In comparison with the comparative example in which the second electrode is not provided, since the third electrode 446 of the present disclosure can be overlapped with the second electrode 444, the area of the third electrode 446 can be enlarged, so that the transmittance can be increased. In general, if the overlapping width D₄ is larger, the transmittance will be higher. However, when the overlapping width D₄ is too large, and the second electrode 444 covers the slit of the third electrode 446, the electric field generated by the second electrode 444 may have interference to the arrangement of the liquid crystal molecules above the third electrode 446 penetrating through the slit, resulting in a decrease in the transmittance. Further, if the overlapping width D₄ is too large, the third electrode 446 and the second electrode 444 will form a larger storage capacitor in the Z-axis direction. The storage capacitor which is too large will cause the sub-pixel SP1 to be insufficiently charged, so it is necessary to increase the size of the sub-pixel switching element (for example, increase the ratio of the channel width to the channel length), thereby improving the charging capacity, but the sub-pixel switching element which is too large will also cause the aperture ratio to be reduced to cause a further decrease in the transmittance, wherein the switching element can be an amorphous thin-film transistor or a low temperature polysilicon thin-film transistor, a metal-oxide thin-film transistor or the hybrid type transistor stated above, but it is not limited thereto, as long as it can be used as N/P-type transistor of the switch, can be useful in the present invention. Therefore, the overlapping width D₄ is not larger than the width of the peripheral portion (the region without the slit) of the third electrode 446, for example, less than or equal to 4 μm, and the effect on the transmittance of the overlapping width D₄ will be further explained below.

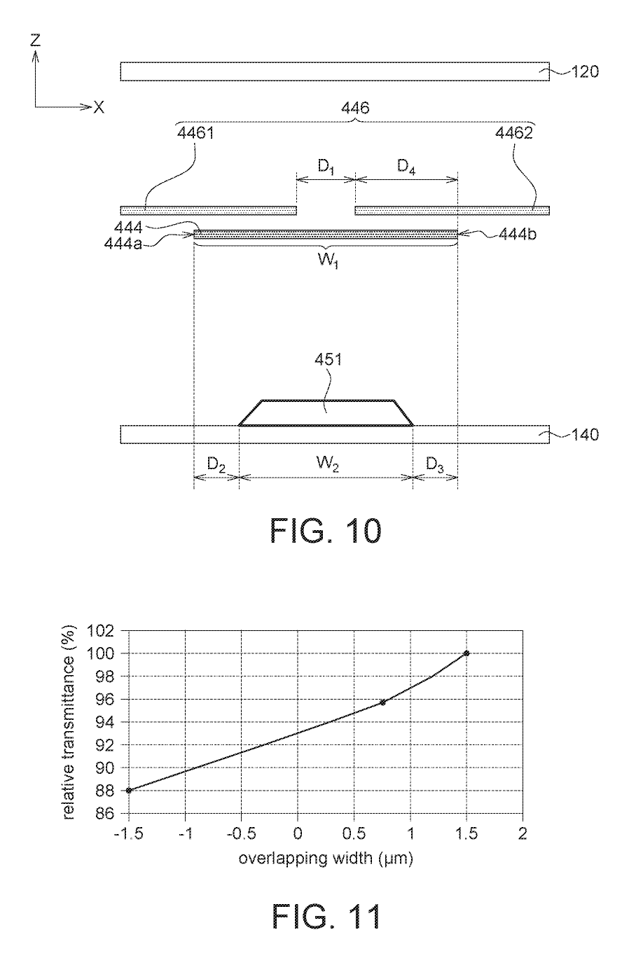

FIG. 11 is a diagram showing a relationship between a relative transmittance and an overlapping width D₄ of a display device according to one further embodiment of the present disclosure. In FIG. 11, the horizontal axis represents the value of the overlapping width D₄. The vertical axis represents the relative transmittance (%) of the display device. When the overlapping width D₄ is greater than 0, it indicates that there is an overlap between the second electrode 444 and the third electrode 446. When the overlapping width D₄ is equal to 0, it means that there is no overlap between the second electrode 444 and the third electrode 446. When the overlapping width D₄ is less than 0, it means that the second electrode 444 and the third electrode 446 are spaced apart by a distance in the X direction. For example, when the overlapping width D₄ is equal to −1.5 μm, it means that there is no overlap between the second electrode 444 and the third electrode 446, and is spaced apart by 1.5 μm in the X direction.

From the results of FIG. 11, it is understood that when the overlapping width D₄ is equal to −1.5 μm, the relative transmittance of the display device is 88%. When the overlapping width D₄ is equal to 0.75 micrometers, the relative transmittance of the display device is 95.5%. When the overlapping width D₄ is equal to 1.5 micrometers, the relative transmittance of the display device is 100%. It can be seen that if the overlapping width D₄ is larger (not more than 4 micrometers, i.e. it can be less than or equal to 4 micrometers and more than zero), the transmittance of the display device can be higher.

One embodiment of the present disclosure provides a display device. Since the display device of the present disclosure can adopt the technology of integrating the color filter on the array substrate, the arrangement error during combining the color filter substrate and the array substrate can be avoided, and the problem that the transmittance variation is larger can be reduced. Furthermore, in comparison with the comparative example in which only the pixel electrode is provided on the second substrate, since the display device of the present disclosure is provided with the second electrode in addition to the pixel electrode (third electrode), the setting range of the electrode can be larger, and the second electrode can also improve the problem of a light leakage in the display device caused by the vertical field and the fringe field of the data line. In addition, the arrangement of the data line can also reduce the color mixing between different colors of the color filter layer. The arrangement of the second electrode and the data line can partially replace the function of the black matrix, so that the installation area of the black matrix on the first substrate can be reduced, so that the light-emitting area can be enlarged, and the display area can be increased. Alternatively, the second electrode may extend in the first direction and the second direction to provide a relatively stable common voltage, improve display quality, and avoid loss of aperture ratio caused by the addition of the via hole.

While the invention has been described by way of example and in terms of the above embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display device, comprising:
a panel, wherein the panel comprises:
a first substrate;
a first electrode disposed on the first substrate;
a second substrate disposed opposite to the first substrate;
a scan line disposed on the second substrate;
a data line disposed on the second substrate and intersecting the scan line;
a first insulating layer disposed on the scan line and the data line;
a second insulating layer disposed on the first insulating layer;
a second electrode disposed between the first insulating layer and the second insulating layer;
a third electrode disposed on the second insulating layer; and
a liquid crystal layer disposed between the third electrode and the first electrode;
wherein the second electrode overlaps the data line in a top view.

2. The display device according to claim 1, wherein the second electrode and the third electrode at least partially overlap each other.

3. The display device according claim 2, wherein the panel further comprises a plurality of data lines, and each of the data lines extends along a first direction, and the data lines are spaced apart along a second direction (X-direction), the second direction is different from the first direction in the top view, wherein the second electrode has a first width in the second direction, and at least one of the data lines has a second width in the second direction, and the first width is greater than the second width.

4. The display device according to claim 3, wherein an absolute value of a difference between the first width and the second width is greater than or equal to 1 micrometer and less than or equal to 8 micrometers.

5. The display device according to claim 1, wherein the data line extends along a first direction, an overlapping width is between the second electrode and the third electrode in a second direction, the second direction is different from the first direction in the top view, and the overlapping width is less than or equal to 4 micrometers and more than zero.

6. The display device according to claim 1, wherein the third electrode further comprising a first pixel electrode and a second pixel electrode, the data line extends along a first direction, a first distance is between the first pixel electrode and the second pixel electrode in a second direction, the second direction is different from the first direction in the top view, the first distance is greater than or equal to 4 micrometers, and less than or equal to 21 micrometers.

7. The display device according to claim 1, wherein both of the first insulating layer and the second insulating layer are an inorganic layer.

8. The display device according to claim 1, wherein the first insulating layer is an organic compound layer, and the second insulating layer is an inorganic layer.

9. The display device according to claim 1, wherein the first insulating layer is an inorganic layer, and the second insulating layer is an organic compound layer.

10. The display device according to claim 1, wherein the second electrode is a ground electrode, a floating electrode or electrically connected to a common electrode.

11. The display device according to claim 1, wherein the panel further comprises a plurality of data lines, and each of the data lines extends along a first direction, and the data lines are spaced apart along a second direction, the second direction is different from the first direction in the top view, wherein a second distance in the second direction is between a first edge of the second electrode and the data line projected on the second substrate, and a third distance in the second direction is between a second edge of the second electrode and the data line projected on the second substrate; and
wherein the second distance is substantially equal to the third distance.

12. The display device according to claim 1, wherein the panel comprises a bottom conductive layer disposed on the second substrate and the bottom conductive layer includes a protrusion.

13. The display device according to claim 12, wherein the third electrode electrically connects to the data line through an via hole, and the via hole is overlapped with the protrusion in the top view.

14. A display panel, comprising:
a first substrate;
a first electrode disposed on the first substrate;
a second substrate disposed opposite to the first substrate;
a scan line disposed on the second substrate;
a data line disposed on the second substrate and intersecting the scan line;
a first insulating layer disposed on the scan line and the data line;
a second insulating layer disposed on the first insulating layer;
a second electrode disposed between the first insulating layer and the second insulating layer;
a third electrode disposed on the second insulating layer; and
a liquid crystal layer disposed between the third electrode and the first substrate;
wherein the second electrode overlaps the data line in a top view.

15. The display panel according to claim 14, wherein the second electrode and the third electrode are at least partially overlapped.

16. The display panel according claim 15, further comprising a plurality of data lines, and each of the data lines extends along a first direction, and the data lines are spaced apart along a second direction, the second direction is different from the first direction in the top view; and
wherein the second electrode has a first width in the second direction, and at least one of the data lines has a second width in the second direction, and the first width is greater than the second width.

17. The display panel according to claim 16, wherein an absolute value of a difference between the first width and the second width is greater than or equal to 1 micrometer and less than or equal to 8 micrometers.

18. The display panel according to claim 14, wherein the data line extends along a first direction, an overlapping width is between the second electrode and the third electrode in a second direction, the second direction is different from the first direction in the top view, and the overlapping width is less than or equal to 4 micrometers and more than zero.

19. The display panel according to claim 14, wherein the third electrode further comprising a first pixel electrode and a second pixel electrode, the data line extends along a first direction, a first distance is between the first pixel electrode and the second pixel electrode in a second direction, the second direction is different from the first direction in the top view, the first distance is greater than or equal to 4 micrometers, and less than or equal to 21 micrometers.

20. The display panel according to claim 14, wherein the display comprises a bottom conductive layer disposed on the second substrate and the bottom conductive layer includes a protrusion.
